(19) United States
(12) Patent Application Publication
(10) Pub. No.: US 2010/0187256 A1
(43) Pub. Date: Jul. 29, 2010

(54) Drip Catcher And Method

(75) Inventor: Eibert Draisma, Amsterdam (NL)

Correspondence Address: HOFFMANN & BARON, LLP, 6900 JERICHO TURNPIKE, SYOSSET, NY, 11791, US

(73) Assignee: DRAISMA INDUSTRIELE VORMGEVING, Amsterdam (NL)

(21) Appl. No.: 12/445,627

(22) PCT Filed: Oct. 17, 2007
(86) PCT No.: PCT/NL07/00267

§ 371 Date: May 28, 2009

(30) Foreign Application Priority Data
Oct. 17, 2006 (NL) 1032696
Nov. 2, 2006 (NL) 1032804

(51) Int. Cl. B67D 1/16; G09F 3/00; B65D 23/06

(52) U.S. Cl. 222/108; 222/1; 40/310; 215/392

(57) ABSTRACT

The present invention provides a drip catcher (1) for a liquid container (10), comprising an at least partially elastic collecting member (2) for collecting droplets (12) during pouring of liquid out of the liquid container (10). The collecting member (2) comprises a core (4) of a number of bundled elastic threads (8) and a jacket (6) of an absorbent material arranged round the core (4). The drip catcher can comprise a collecting member (2) and a label (32) coupled thereto. The label (32) can be releasable and reusable as door hanger (74) and the like. The label and/or the collecting member can be provided with an imprint (40). The material from which the drip catcher is made comprises for instance polymer foam, felt, cardboard and the like.

### CROSS-REFERENCE TO RELATED APPLICATIONS

This application is the National Stage of International Application No. PCT/NL2007/000267, filed Oct. 17, 2007, which claims the benefit of Netherlands Application Nos. NL 1032696, filed Oct. 17, 2006, and NL, 1032804, filed Nov. 2, 2006, the contents of which are incorporated by reference herein.

### FIELD OF THE INVENTION

The present invention relates to a drip catcher and a method therefore. Such a drip catcher has the task of collecting droplets which run down a bottle, a teapot and the like after pouring therewith.

### BACKGROUND OF THE INVENTION

Known from FR-964.439 is a drip catcher which consists of a ring of absorbent material provided with an elastic core. A casing of metal or plastic is arranged around the ring. The known drip catcher is however not applied in practice, or hardly so, since the production costs are relatively high for large-scale application. (Wine) bottles are therefore not sold in a form where the bottle is already provided with a drip catcher, this only being arranged when the bottle is used.

### SUMMARY OF THE INVENTION

The present invention has for its object to provide a simpler drip catcher with more application options.

A drip catcher according to the present invention comprises for this purpose an at least partially elastic collecting member for collecting droplets during pouring of liquid out of the liquid container.

The construction of the drip catcher is relatively simple and therefore inexpensive. The drip catcher can therefore already be arranged round the neck of a drink-containing bottle when it is sold, thereby greatly increasing the field of application. After use the drip catcher can be discarded or reused. It acts as a means to advertise and distinguish the drink-containing bottles which are provided with the drip catcher according to the invention since, as described above, other drip catchers have been found to be too expensive for such large-scale application.

In an embodiment the collecting member comprises an elastic part substantially for exerting a clamping force, and an absorbent part co-acting with the elastic part for the purpose of absorbing the droplets.

The elastic part of the collecting member optionally comprises a core of a number of bundled elastic threads.

The absorbent part of the collecting member can comprise a jacket of an absorbent material arranged round the core.

The jacket is preferably relatively thin compared to the core.

The collecting member can take an annular form with an inner diameter (D1) of about 25 mm and/or a diameter (D2) of between about 1.5 and about 4 mm.

In another embodiment the drip catcher comprises a label element coupled to the collecting member.

The label element is optionally coupled releasably to the collecting member, wherein a label element detached from the collecting member comprises a second opening for the purpose of arranging the label element therewith to for instance a door handle.

The collecting member can be a disc with a thickness in the order of 1 to 2 mm.

The collecting member optionally has an outer edge with a form varying from a circle, such as a heart shape or a flower shape.

The label element is optionally a (post)card, decorative element, label and/or door hanger.

The collecting member and/or the label element are preferably provided with an imprint.

According to a further aspect, the invention provides a method for use of a drip catcher substantially as described above.

### BRIEF DESCRIPTION OF THE DRAWINGS

Further advantages and features of the present inventions will be elucidated with reference to the accompanying drawings, in which:

FIG. 1 shows an embodiment of a drip catcher according to the present invention;

FIG. 2 shows a partially broken-away perspective view of the drip catcher of FIG. 1;

FIG. 3 shows a bottle with a neck provided with the drip catcher of FIG. 1;

FIG. 4 shows a detail in cross-section along IV in FIG. 3;

FIG. 5 shows a top view of a second embodiment of a drip catcher according to the present invention;

FIG. 6 is a bottom view of the drip catcher of FIG. 5;

FIG. 7 is a perspective bottom view of the drip catcher of FIG. 5;

FIG. 8 is a perspective top view of the drip catcher of FIG. 5;

FIG. 9 shows a perspective view of a bottle provided with the drip catcher of FIG. 5;

FIG. 10 shows the bottle of FIG. 9, wherein the label element has been removed from the collecting member;

FIG. 11 shows a third embodiment of a drip catcher according to the present invention;

FIG. 12 shows a bottle provided with the drip catcher of FIG. 11;

FIG. 13 shows the bottle of FIG. 12, wherein the label element has been removed from the collecting member;

FIG. 14 is a top view of a fourth embodiment of a drip catcher according to the invention;

FIG. 15 shows a top view of the drip catcher of FIG. 14, wherein the collecting member has been detached from the label element;

FIG. 16 shows a door handle provided with the label element of FIG. 15;

FIG. 17 shows a bottle provided with the drip catcher of FIG. 14;

FIG. 18 shows the bottle of FIG. 17, wherein the label element has been removed from the collecting member;

FIG. 19 shows a perspective bottom view of a fifth embodiment of a drip catcher according to the present invention;

FIG. 20 shows a perspective top view of the drip catcher of FIG. 19;

FIG. 21 is a top view of the label element of the drip catcher of FIG. 19;

FIG. 22 is a side view of the drip catcher of FIG. 19;

FIG. 23 shows a bottle provided with the drip catcher of FIG. 19;

FIG. 24 shows a sixth embodiment of a drip catcher according to the present invention;

FIG. 25 shows a bottle provided with the drip catcher of FIG. 24;

FIG. 26 shows the bottle of FIG. 25, wherein the label element has been removed from the collecting member;

FIG. 27 shows a perspective bottom view of another embodiment of a drip catcher according to the present invention;

FIG. 28 is a perspective top view of the drip catcher of FIG. 27;

FIG. 29 shows another perspective bottom view of the drip catcher of FIG. 27;

FIG. 30 is a side view of the drip catcher of FIG. 27;

FIG. 31 shows a bottle provided with the drip catcher of FIG. 27;

FIG. 32 is a perspective view of another embodiment of a drip catcher according to the present invention;

FIG. 33 is a perspective view of yet another embodiment of a drip catcher according to the invention;

FIG. 34 is a top view of the collecting member of the drip catcher of FIG. 32 and/or 33;

FIG. 35 shows a folded-open label element of the drip catcher of FIG. 32;

FIG. 36 shows a folded-open label element of the drip catcher of FIG. 33;

FIG. 37 is a perspective view of a label element;

FIG. 38 is a perspective view of another embodiment of a drip catcher according to the present invention provided with the label element of FIG. 37;

FIG. 39 shows the folded-open label element of FIG. 37;

FIG. 40 shows a bottle provided with the drip catcher of FIG. 32;

FIG. 41 shows a bottle provided with the drip catcher of FIG. 33;

FIG. 42 shows a bottle provided with the drip catcher of FIG. 38;

FIG. 43 shows another embodiment of a drip catcher according to the present invention;

FIG. 44 is a perspective bottom view of the drip catcher of FIG. 43;

FIG. 45 is a perspective top view of the drip catcher of FIG. 43;

FIG. 46 shows another embodiment of a label element;

FIG. 47 shows a drip catcher with the label element of FIG. 46;

FIG. 48 shows a bottle provided with the drip catcher of FIG. 47;

FIG. 49 shows another embodiment of a label element;

FIG. 50 shows a bottle provided with the drip catcher of FIG. 47 from which the label element has been removed;

FIG. 51 shows another embodiment of a drip catcher according to the invention;

FIG. 52-56 show label elements according to the present invention;

FIGS. 57 and 58 show a bottle provided with another embodiment of a drip catcher according to the invention;

FIGS. 59 and 60 show a bottle provided with another embodiment of a drip catcher according to the invention;

FIGS. 61 and 62 show another embodiment of a drip catcher according to the present invention;

FIGS. 63 and 64 show a bottle provided with the drip catcher of FIG. 61;

FIGS. 65 and 66 show an embodiment of a collecting member;

FIG. 67 shows a bottle provided with the collecting member of FIG. 65; and

FIG. 68 shows a detail of a section of the bottle with collecting member of FIG. 67.

### DETAILED DESCRIPTION OF PREFERRED EMBODIMENTS

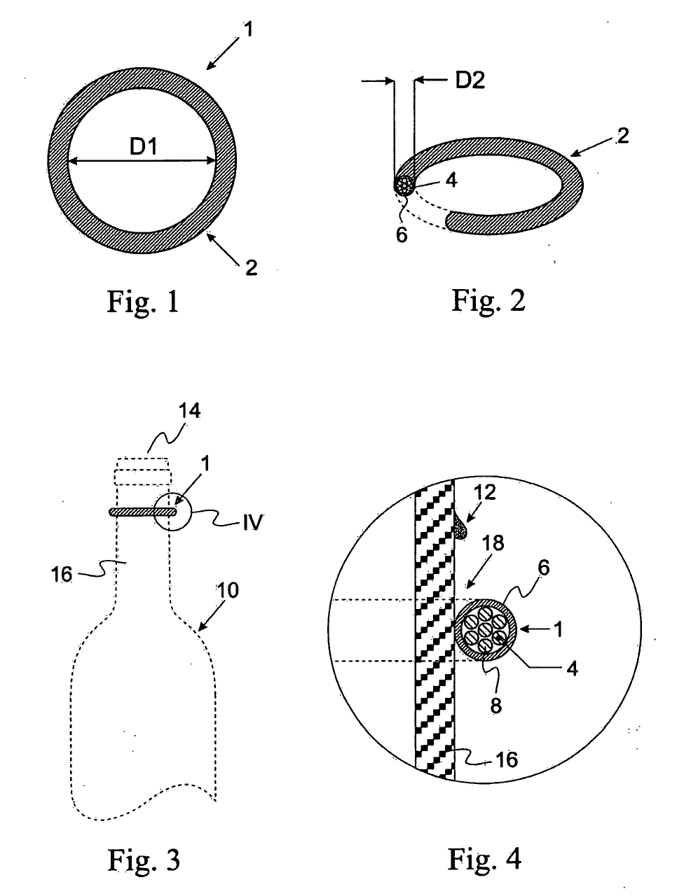

A drip catcher according to the present invention comprises in a first embodiment a collecting member 2 (FIG. 1) which is annular. The annular collecting member 2 comprises a core 4 (FIG. 2) around which a jacket 6 is arranged. As shown clearly in FIG. 4, core 4 comprises a number of threads 8, for instance seven threads. The threads are preferably elastic. Jacket 6 comprises an elastic moisture-adsorbing material. Jacket 6 has a thickness which is preferably small relative to the radius of core 4.

FIG. 3 shows a bottle 10 provided with a drip catcher 1 according to the present invention. The inner diameter D1 (FIG. 1) of the annular collecting member 2 is a little smaller than the outer diameter of the (neck of the) bottle for which the drip catcher is intended. Inner diameter D1 is in practice in the order of for instance 25 mm. The thickness of the ring, i.e. diameter D2, can be relatively small. Diameter D2 is for instance between about 1.5 and about 4 mm.

The operation of the drip catcher of FIG. 1-4 is based as follows on the combination of thread bundle 4 and jacket 6. After drink has been poured out of bottle 10 the bottle is put down in upright position, wherein a droplet 12 runs downward from the bottle opening 14 along neck 16 of the bottle in the direction of drip catcher 1. Collecting channel 18 is situated between bottle neck 16 and drip catcher 1. As soon as droplet 12 reaches the collecting channel, it is spread around bottle neck 16 due to the capillary action and the surface tension of the moisture of droplet 12. The droplet is herein absorbed by jacket 6. In addition, the droplet is suctioned into the drip catcher by the capillary action of the spaces between threads 8. Due to the combined adsorption by thread bundle 4 and jacket 6 the drip catcher can already provide a sufficient adsorption with a small diameter D2.

The (wine) bottles offered for sale in a retail premises are often provided with a label on which is arranged information relating to the content of the bottle. U.S. Pat. No. 1,853,622 provides such a label comprising a card provided with an opening for the neck of a bottle. The function of the known label is however limited to the retail premises. After purchase of the bottle the label is immediately discarded.

The application options of a drip catcher as described above can be extended by combining thereof with a label element, such as a (post)card, decorative element, label and/or door handle.

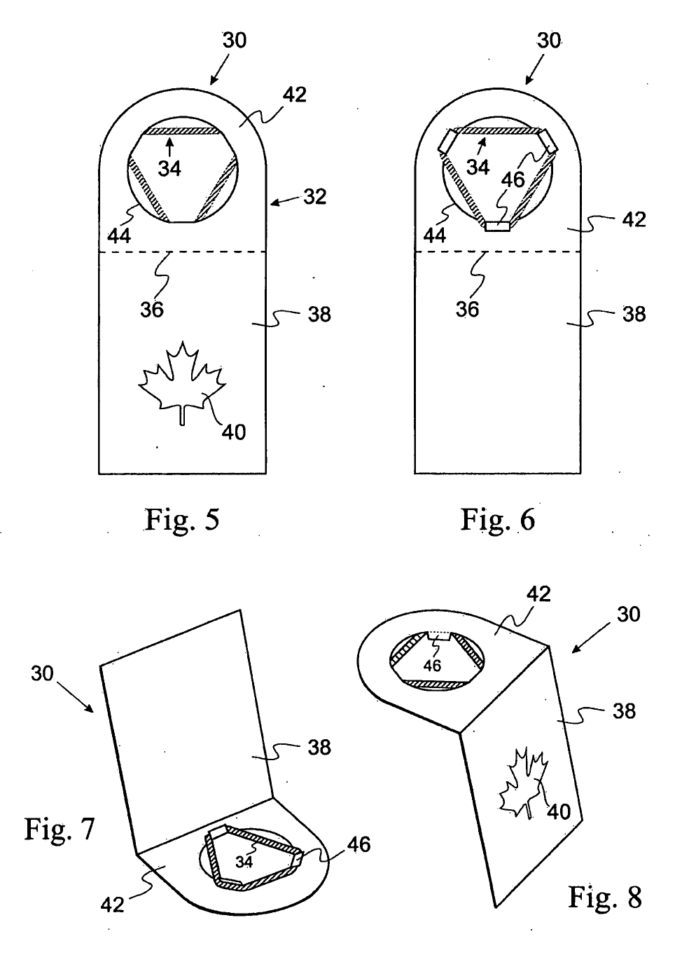

FIGS. 5-8 show a drip catcher 30 comprising a label element 32 coupled to a collecting member 34 for collecting droplets. The collecting member comprises for instance a drip catcher as described with reference to FIGS. 1-4. The label element is for example a card provided with a bend line 36. A first part 38 of the card can be provided with a random imprint 40, such as an informative text and/or advertising. A second part 42 can be bent along bend line 36 relative to the first part, and is provided with an opening 44 for a bottle neck. The edge of opening 44 is provided with a number of upright projections 46, for instance three, around which the collecting member 34 is hooked.

Card 32 is for instance of cardboard or plastic. The bend line can form a weakened portion so that the first and second part can be given a firmer form.

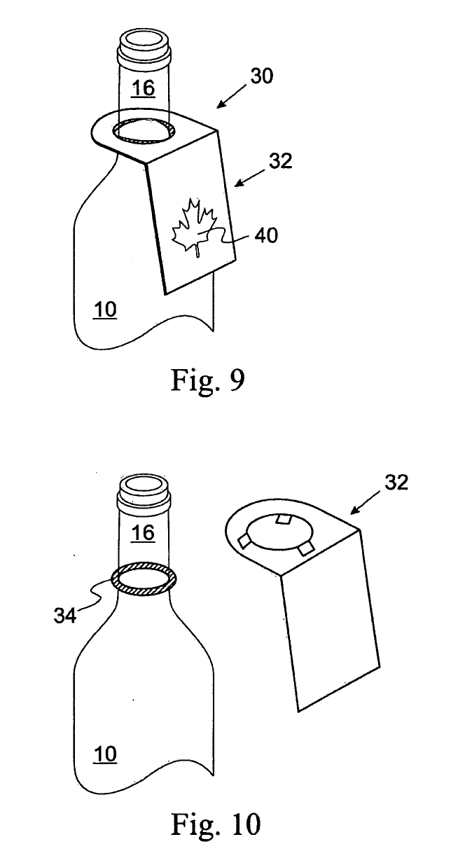

FIG. 9 shows the use of the drip catcher of FIG. 5-8. Drip catcher 30 is arranged with opening 44 round neck 16 of bottle 10, while information 40 is arranged on the label 32 attached thereto. Collecting member 34 herein provides for a clamping attachment around the neck, so that the label attached thereto can be arranged at a random height along neck 16.

As shown in FIG. 10, a consumer can remove the label after buying the bottle, wherein the collecting member remains behind around the neck and will still function as drip catcher.

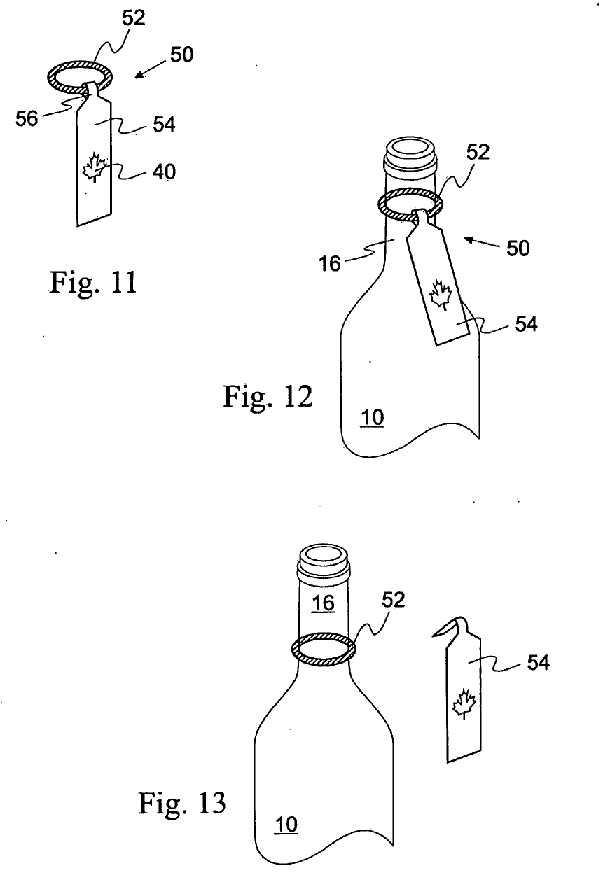

In another embodiment (FIG. 11-13) drip catcher 50 comprises a collecting member 52 and a label 54 coupled thereto. Label 54 is for instance an elongate strip with a folded part 56 on an outer end for the purpose of forming a breakable coupling to the collecting member (FIG. 11). The label is provided with a random imprint 40.

During use the drip catcher is arranged round neck 16 of bottle 10. The label can be removed from the collecting member by breaking the folded part 56, as shown in FIG. 13.

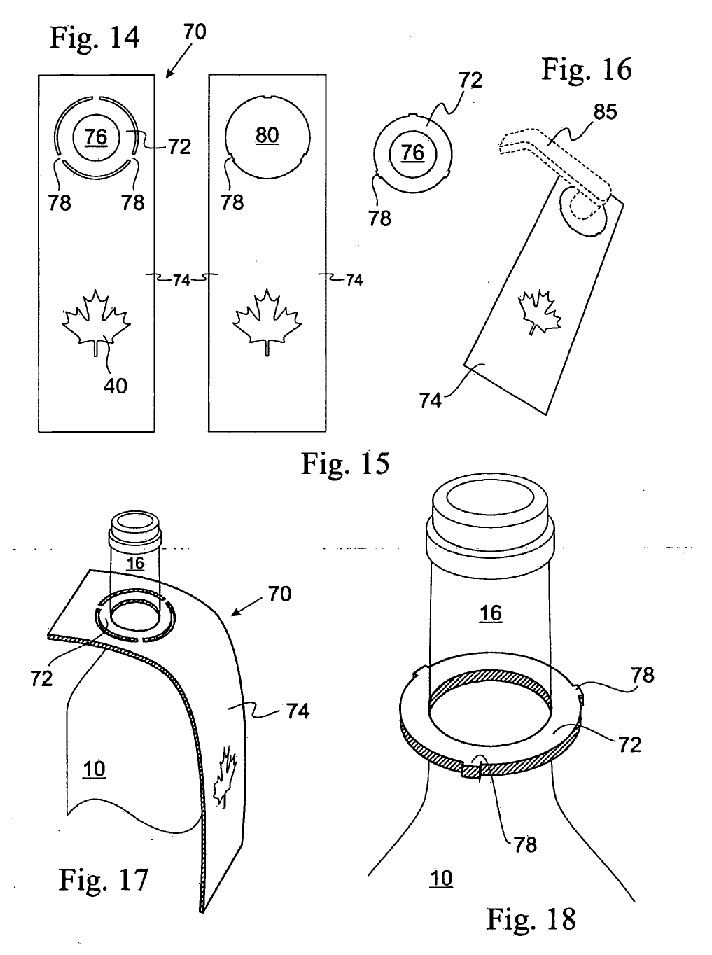

In yet another embodiment drip catcher 70 (FIG. 14-18) comprises a collecting member 72 and a label 74. The label is provided with random imprint 40.

When coupled (FIG. 14), collecting member 72 and label 74 form an elongate strip. The collecting member is a flat ring provided with a first opening 76 with an inner diameter slightly smaller than the outer diameter of neck 16 of bottle 10 (FIG. 17). The ring is provided with coupling pieces 78 at a number of positions, for instance three, distributed equally over the periphery.

The label is an elongate strip in which a second opening 80 (FIG. 15) is arranged with a diameter substantially corresponding to the outer diameter of ring 72.

Drip catcher 70 is manufactured by punching recesses out of an elongate strip of a suitable material. The punched recesses comprise slots or incisions between coupling pieces 78 in addition to the opening 76. Ring 72 remains connected to label 74 via the material of the three coupling pieces 78 that have not been punched out. Opening 80 is created only when ring 72 is removed by breaking the parts 78.

The use of the drip catcher substantially corresponds to that of the above described embodiments. The assembly 70 of drip catcher 72 and label 74 is for instance prearranged round neck 16 of bottle 10 and sold thus to a consumer (FIG. 17). After purchase the consumer can remove label 74 from drip catcher 72. This latter remains around neck 16 for the purpose of collecting droplets which run down along neck 16 after drink has been poured (FIG. 18). Label 74 removed from collecting member 72 can be reused as label, for instance be arranged as door hanger on a door handle 85 (FIG. 16).

Droplet collector 70 as shown in FIG. 14 will in practice be manufactured substantially wholly from the same material. The material should be able to absorb moisture to a sufficient extent to take up several droplets. Suitable materials are for instance polymer foam, felt, cardboard and the like. The thickness of drip catcher 70 is for instance in the order of 1 to 2 mm.

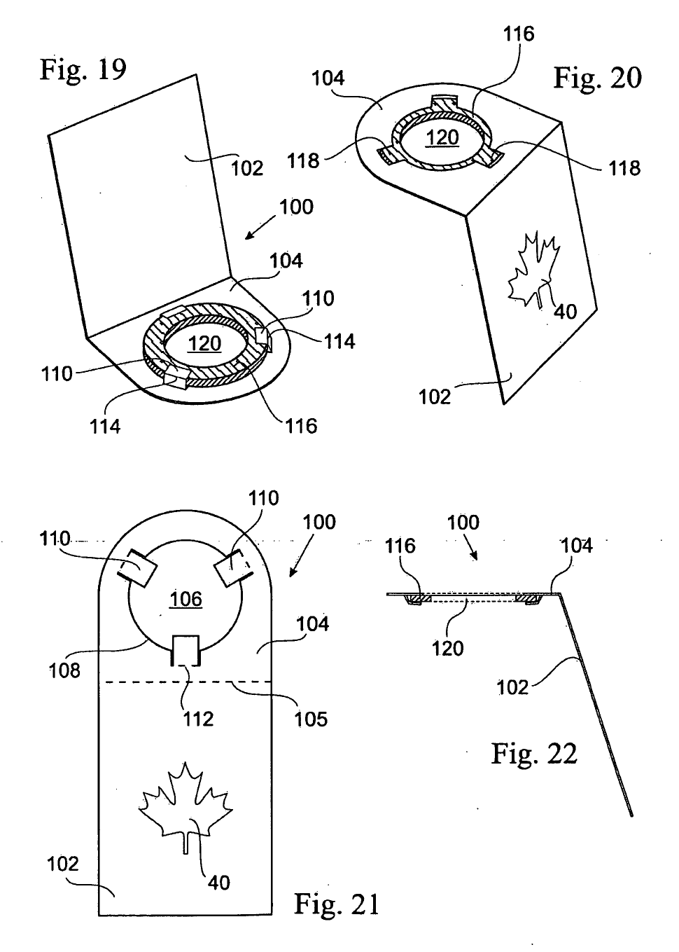

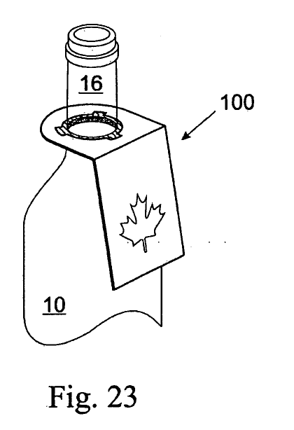

Another embodiment (FIG. 19-23) of drip catcher 100 comprises a card-like body comprising a first part 102 and a second part 104. Second part 104 can be bent along a bend line 105 relative to first part 102 (FIG. 21). Arranged in second part 104 is an opening 106 with a side edge 108 provided with a number of, for instance two, three or four protrusions 110. Protrusions 110 can be folded twice along fold lines 112 and 114. A collecting member 116 can be arranged between the folded protrusions 110 and second part 104 (FIG. 19, 20, 22). The folded protrusions leave openings 118 in the second part. Collecting member 116 is a flat ring of a constant thickness. The ring has a smooth outer edge and a smooth inner edge. The ring is provided in the middle with an opening 120 (FIG. 19) for arranging of the ring around the neck of a bottle (FIG. 23).

The use of drip catcher 100 corresponds to the use of the above described embodiments.

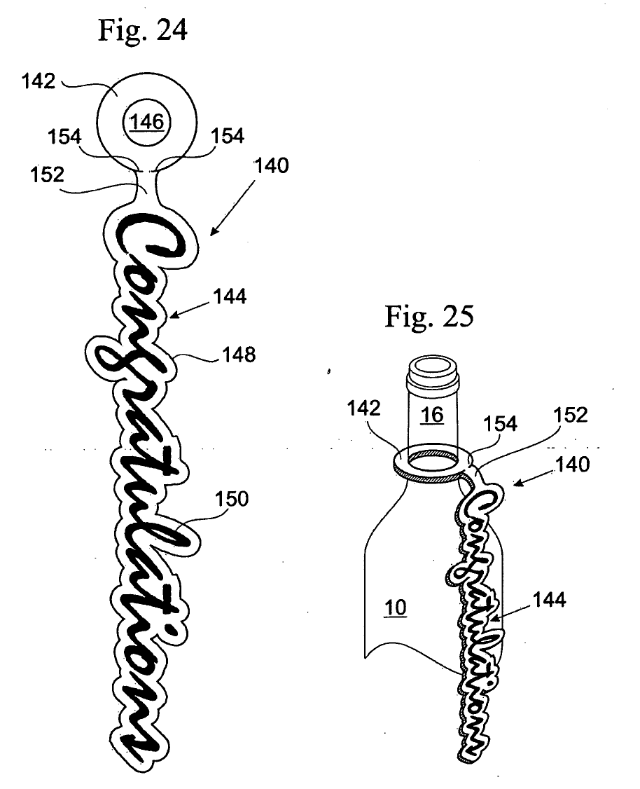

In yet another embodiment drip catcher 140 (FIG. 24-25) comprises a collecting member 142 and a label 144 coupled thereto. The collecting member is a flat ring provided in the centre with a round opening 146 for neck 16 of bottle 10. The label is formed integrally with the collecting member. An outer contour 148 of the label follows an imprint 150 applied to the label. As shown, the imprint can comprise letters, but also numbers, figures and other random images.

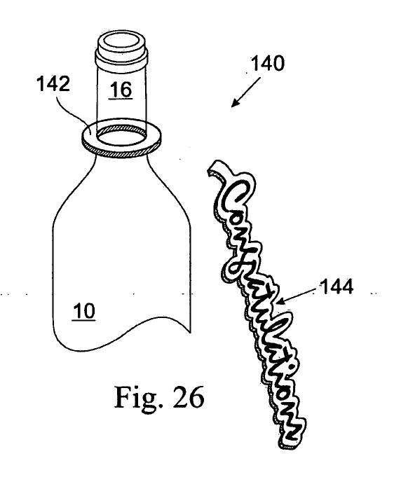

In FIG. 26 the label 144 is disconnected from annular drip catcher 142. Collecting member 142 remains behind round bottle neck 16. The connection between collecting member 142 and label 144 is broken at the position of incisions or recesses 154 in narrowed portion 152 (FIG. 24, 26).

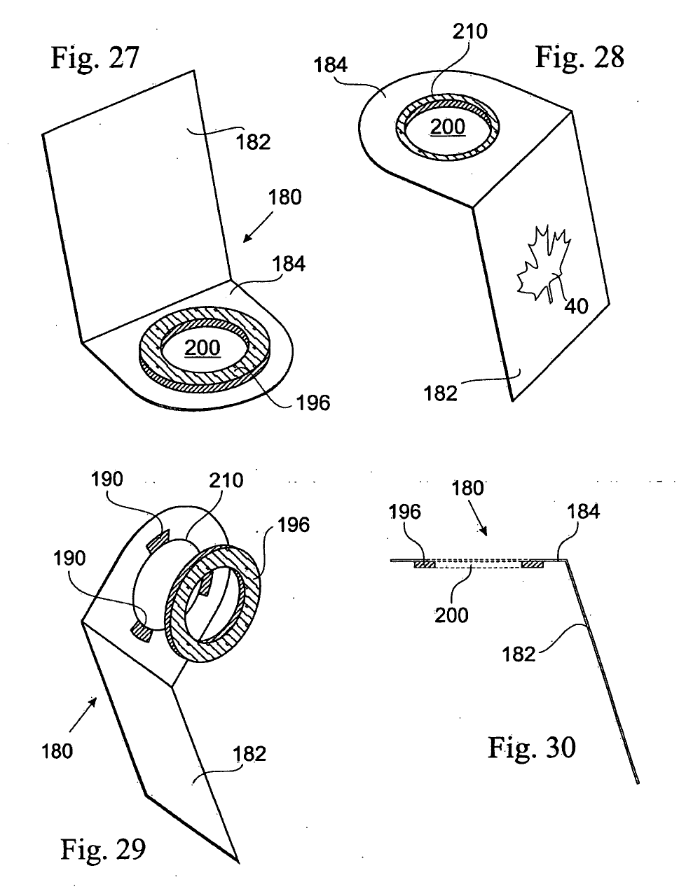

In another embodiment as shown in FIG. 27-30, drip catcher 180 comprises a label element comprising a first part 182 and a second part 184. In the shown embodiment the first and second part are parts of a card-like label attached in bendable manner to each other. Arranged in the second part is an opening 210 which coincides with an opening 200 in the centre of annular collecting member 196.

Collecting member 196 substantially corresponds to collecting member 116 as described with reference to and shown in FIG. 19-23.

Collecting member 196 is coupled to second part 184 by means of adhesive connections 190. The adhesive connections are provided with a suitable adhesive, such as glue or double-sided adhesive tape. The adhesive connection between collecting member 196 and the label is preferably easy to break, for instance in that the glue has a relatively small adhesive force.

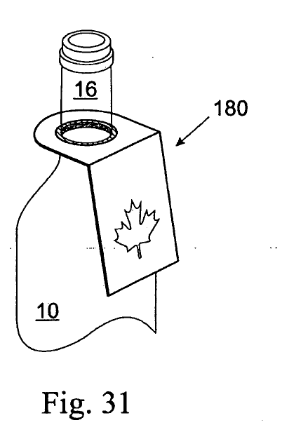

FIG. 31 shows bottle 10 with neck 16 around which drip catcher 180 is arranged. Imprint 40 is applied to drip catcher 180.

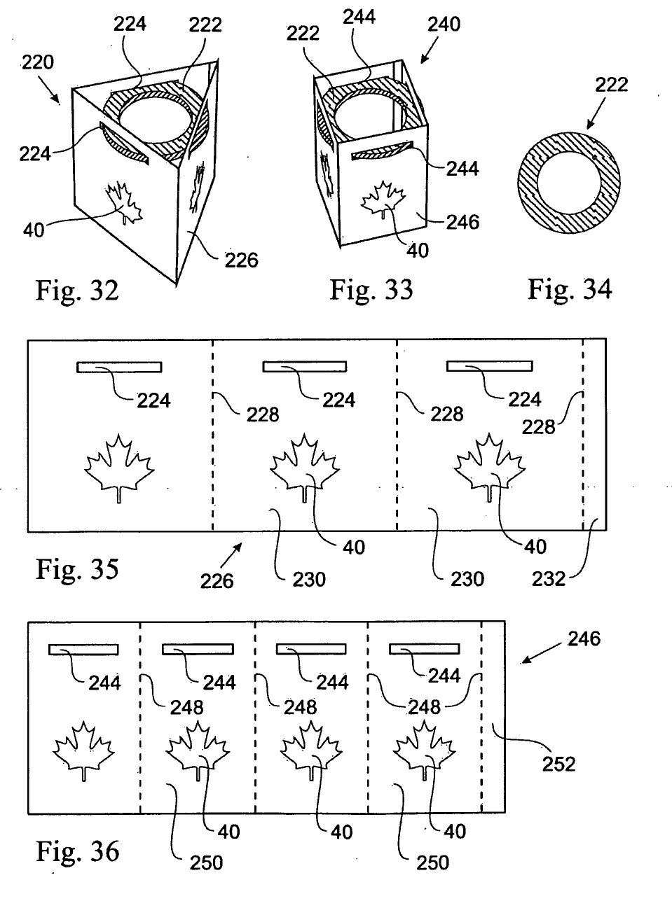

FIG. 32 shows drip catcher 220 which is provided with a collecting member 222 arranged in slots 224 of label 226. Collecting member 222 substantially corresponds to one or more of the above described collecting members 52, 116, 196. Label 226 has a tubular form which is triangular in top view. The label is provided at random locations with a random imprint 40.

FIG. 33 shows drip catcher 240 which is provided with a collecting member 222 arranged in slots 244 of label 246. Label 246 has a tubular form which is substantially square or elongate in top view. The label is provided at random locations with a random imprint 40.

FIG. 34 shows collecting member 222 separately. After removal of the label the collecting member will remain behind around the liquid container for the purpose of collecting droplets.

FIG. 35 shows label 226 in folded-open position. Label 226 comprises an elongate card in which slots 224 are arranged and which is provided with a number of fold lines 228. Straight surfaces 230 are formed between the fold lines. At an outer end the card is provided with a protruding edge 232.

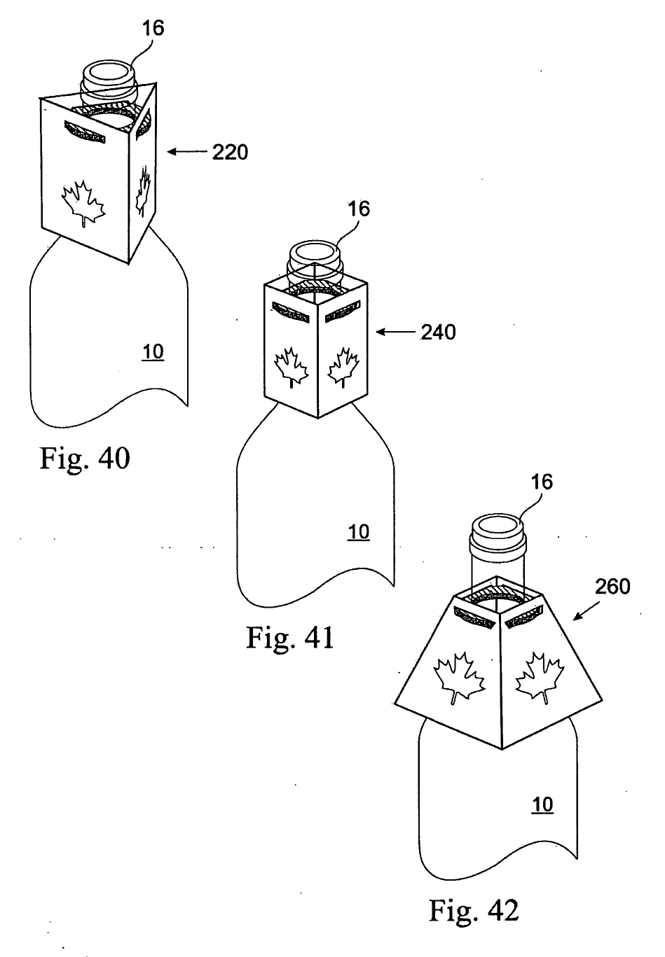

One or more imprints 40 are applied to one side of the card. In use this will be the visual side, see FIG. 32 and FIG. 40. The other side of the card can likewise be printed, but generally remains blank or plain.

In order to obtain the form as shown in FIG. 32 the surfaces 230 are folded along folding edges 228. Edge 232 is then attached to the inner side of the opposite outer end of the card, for instance by glueing and/or stapling.

FIG. 36 shows label 246 in folded-open position. Label 246 comprises an elongate card provided with slots 244 and fold lines 248 for the purpose of forming surfaces 250. At an outer end the card is provided with protruding edge 252 with a function corresponding to the function of edge 232.

As shown in FIGS. 35 and 36, any desired number of surfaces 230, 250 can be formed by providing the card with a corresponding number of fold lines. Tubular forms can thus be obtained which are triangular (FIG. 32) or square (FIG. 33), but also shapes with five, six or more sides in top view.

FIG. 38 shows drip catcher 260 which is provided with a collecting member 222 arranged in slots 264 of label 266.

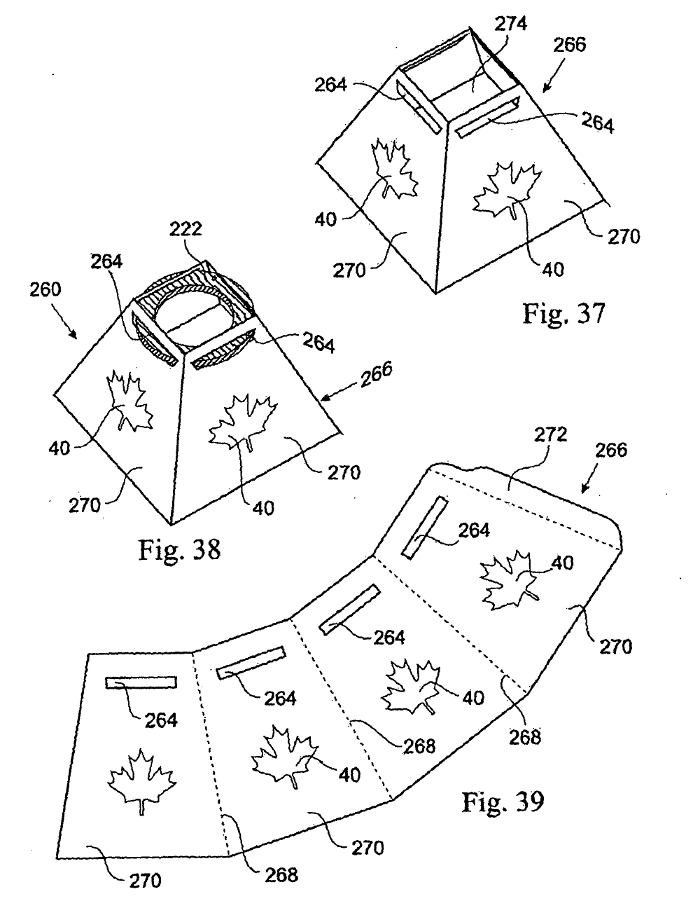

Label 266, which is shown separately in FIG. 37, has a pyramid form with an open top side, i.e. the top of the pyramid has been removed and leaves an opening 274, for instance for a bottle neck. The label is provided at random locations with a random imprint 40.

FIG. 39 shows label 266 in folded-open position. The label comprises a card provided with fold lines 268 for forming surfaces 270. At an outer end the card is provided with an adhesive edge 272. Since the surfaces 270 for forming a pyramid have a wider base and a narrower top, fold lines 268 are arranged at an angle to each other. The angle, which is for instance between 15 and 25 degrees, likewise determines the inclination of surfaces 270 in the folded position (FIG. 37).

FIGS. 40, 41 and 42 show a bottle 10 with a neck 16 provided with the drip catcher of FIGS. 32, 33 and 38 respectively. The use substantially corresponds to that of the drip catchers as described above.

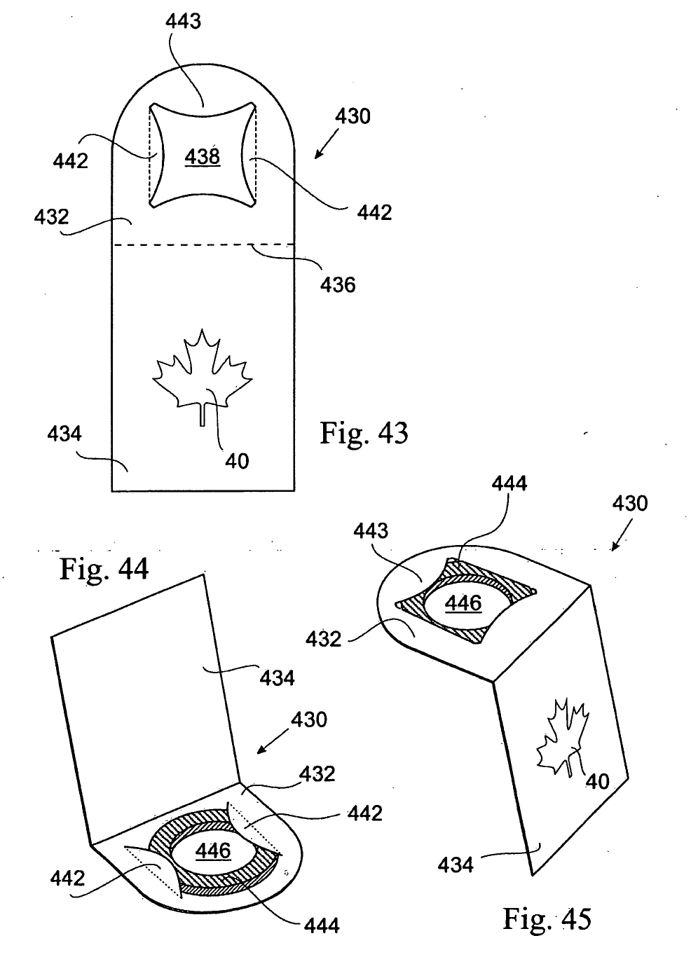

FIG. 43-45 show an embodiment of drip catcher 430 comprising a card-like, elongate label 434 with imprint 40 and fold line 436. Arranged in the label is opening 438 with edges which form curved bulges 442, 443. A disc-like collecting member 444 is clamped between bulges 442 on the one side and bulges 443 on the other.

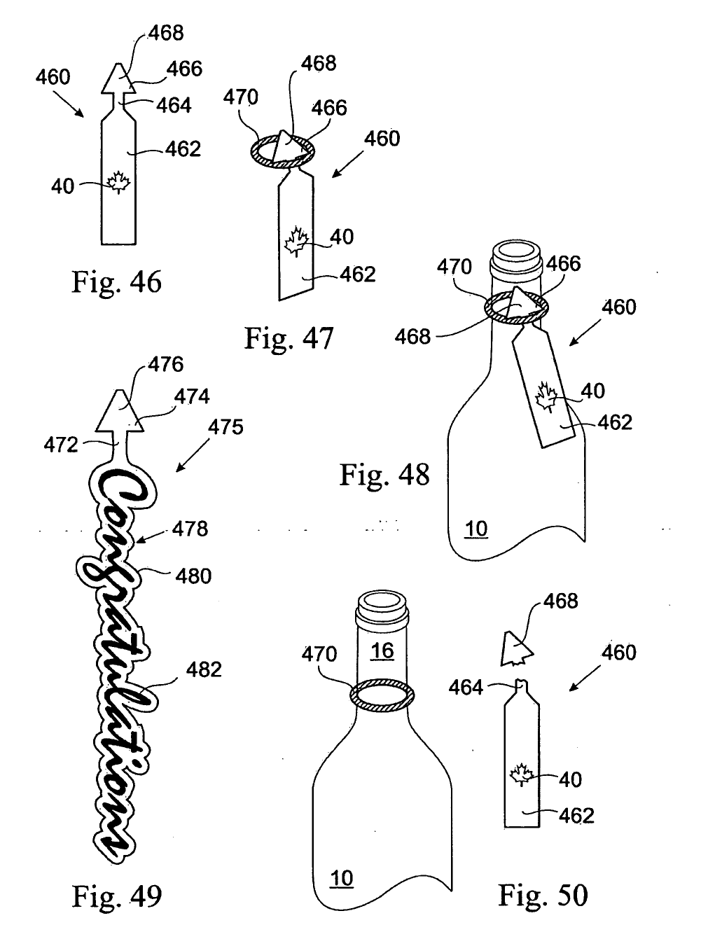

FIGS. 46-48 and 50 show an embodiment of drip catcher 460 comprising elongate label 462 with imprint 40, narrowed portion 464 and arrow-shaped outer end 468. The arrow-shaped portion 468 has an edge 466 with which the outer end can be hooked behind collecting member 470 (FIG. 47) and can be arranged thus round a bottle neck 16 (FIG. 48). The narrowed portion 464 is chosen such that the label can be easily torn with the hand at the position of the narrowed portion in order to be removed (FIG. 50).

FIG. 49 shows label 475 with elongate part 478 to which lettering 482 has been applied. The contour 480 of part 478 substantially follows lettering 482. Label 475 comprises narrowed portion 472 and arrow-shaped outer end 476 with edge 474. The use of label 475 corresponds to the use of label 460.

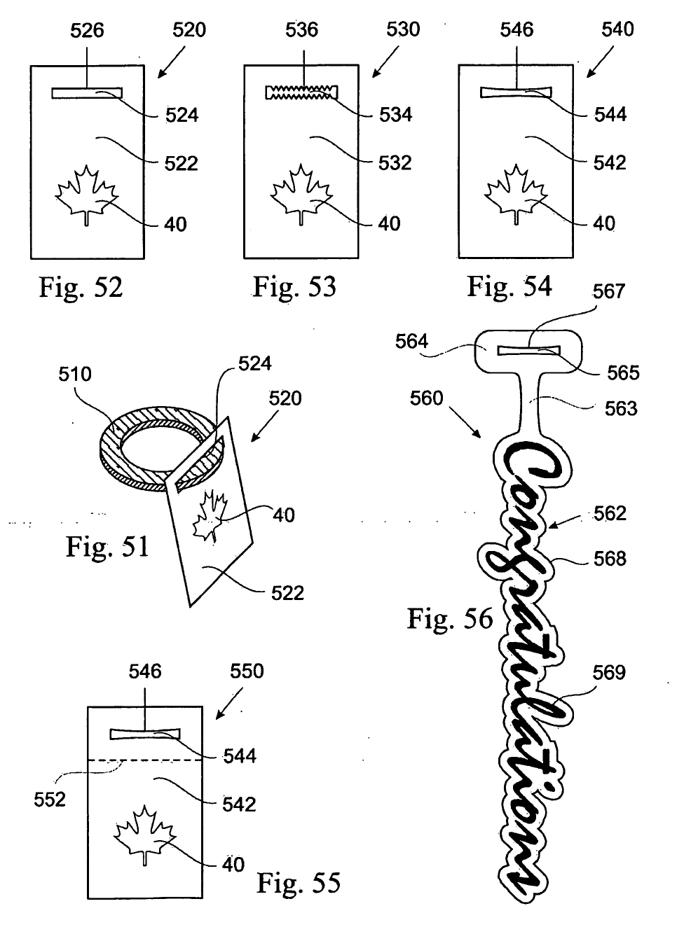

FIG. 51 shows drip catcher 520 provided with label 522 with imprint 40 and collecting member 510. The collecting member corresponds for instance to the collecting member shown in FIG. 19 or 26. Arranged in label 522 is slot 524 (FIG. 52) in which collecting member 510 can be arranged clampingly and releasably as shown in FIG. 51. Slot 524 has a straight edge 526.

FIG. 53 shows label 532 of drip catcher 530 in which slot 534 is arranged. In order to improve the releasable connection to the collecting member, the edge of slot 534 comprises serrations 536.

FIG. 54 shows label 542 of drip catcher 540 in which slot 544 is arranged. In order to improve the releasable connection to the collecting member, the edge of slot 544 comprises curved bulges 546.

FIG. 55 shows label 550 with elongate portion 542 which is connected via bend line 552 to a portion in which slot 544 with edge 546 is arranged.

FIG. 56 shows a label 560 for a drip catcher according to the invention provided with elongate part 562 to which lettering 569 has been applied. The contour 568 of part 562 substantially follows lettering 569. Label 560 has narrowed portion 563 which is connected to widened portion 564 in which slot 565 with curved bulges 567 is arranged.

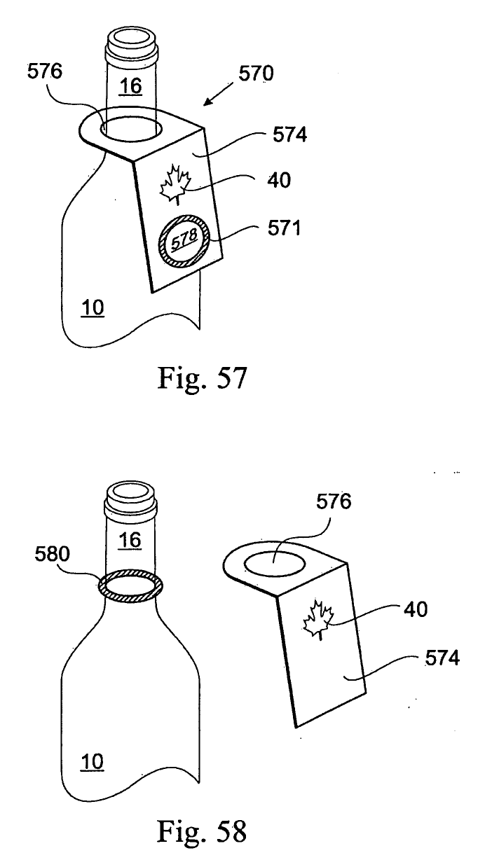

FIG. 57-64 show commercially attractive embodiments of a label combined with a collecting member to form a drip catcher according to the invention. The shown embodiments form a combination which is relatively inexpensive to produce and which can herein be arranged with a standard automatic label applicator, usually without this applicator having to be modified, i.e. in the drip catchers shown in FIG. 57-64 there is no relation between the collecting member and the manner in which the drip catcher has been or is arranged round the liquid container. Drip catcher 610 is usually attached round the liquid container as shown in FIG. 63, wherein the collecting member is arranged around the second opening, i.e. not round the neck of the liquid container.

Automatic label applicators have replaced manual arrangement of hanging bottle labels. An automatic label applicator arranges for instance an average of 350 labels per minute (or more than 5 per second). The labels are supplied from a roll and are severed in the applicator and subsequently arranged round the neck of the bottle. The automatic label applicators are designed to arrange paper and/or plastic labels round bottle necks. The automatic label applicator must sometimes be modified in order to arrange disc-like (EVA) collecting members of the drip catchers (as shown in for instance FIG. 26).

The drip catchers shown in FIG. 57-64 form a combination of label and drip catcher which can be arranged with standard equipment.

In FIG. 57 drip catcher 570 comprises a collecting member 571 which is attached to label 574 with for instance glue. Two openings 576, 578 are arranged in label 574. Collecting member 571 is arranged around opening 578 and can thus be easily removed. Collecting member 571 substantially corresponds to for instance a collecting member as shown in FIG. 1-4, FIG. 19 or FIG. 26. Opening 576 is left clear, whereby it can be arranged round bottle neck 16 by the automatic label applicator.

In FIG. 58 the label comprises a single opening 576 with which the label can be arranged round bottle neck 16 by the automatic label applicator. Collecting member 580 substantially corresponds to for instance a collecting member as shown in FIG. 1-4, FIG. 19 or FIG. 26. Collecting member 580 is for instance glued to the back of label 574, i.e. on the non-visual side.

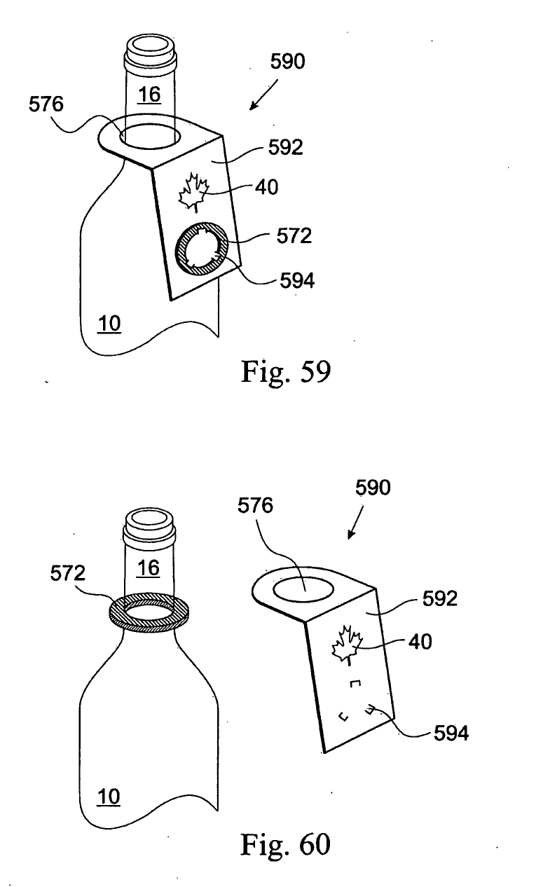

In FIGS. 59 and 60 a drip catcher 590 is shown comprising a collecting member 572 and a label 592. The collecting member corresponds to for instance collecting member 116 in FIG. 19. Label 592 is provided with opening 576 with which the label can be arranged round bottle neck 16 by the automatic label applicator. The label is further provided with a number of protrusions 594 (for instance three) to clamp the collecting member releasably to the label. Protrusions 594 are for instance relatively small, folded-back parts of the label.

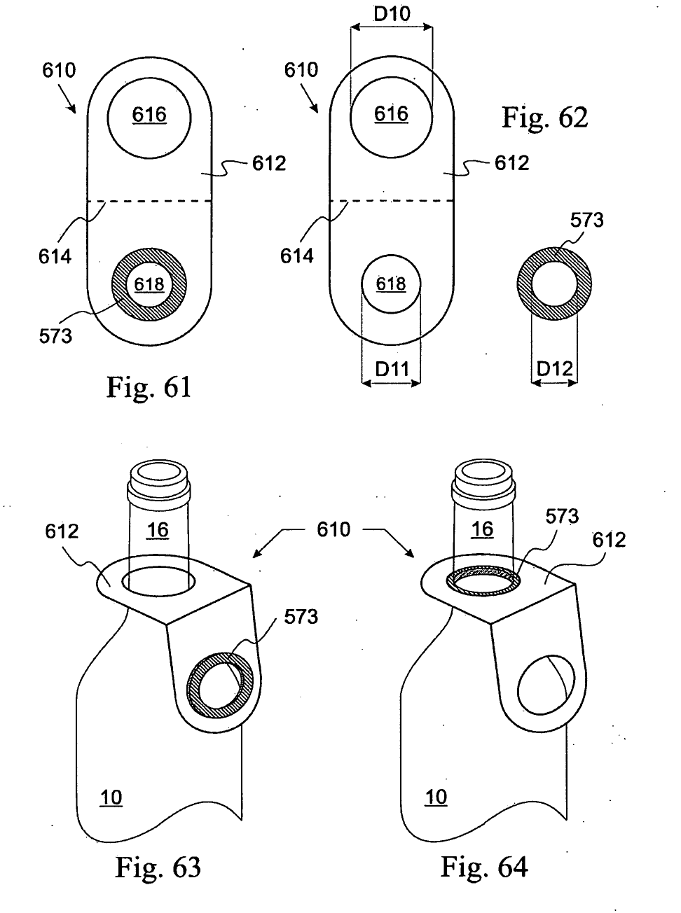

FIG. 61-64 show a drip catcher 610 comprising a collecting member 573 attached to label 612. Two openings 616, 618 are arranged in label 612. Opening 616 has a diameter D10 which fits loosely round neck 16, while opening 618 has a smaller diameter D11. Arranged around opening 618 is collecting member 573 with an inner diameter D12 which is smaller than diameter D11. Label 612 can thus be attached round bottle neck 16 with drip catcher 573 as well as with the standard label hole 616.

Opening 616 has a larger diameter than a bottle neck 16. Opening 618 has a larger diameter than the inner diameter D12 of drip catcher 573. The combination 610 of label with drip catcher can be arranged over a bottle neck 16 such that drip catcher 573 is visible (i.e. on the front of the label) or invisible (i.e. behind the label).

The drip catcher has in practice a thickness of about 1 to 5 mm. The material used is, in addition to being adsorbent, also elastic. A suitable material comprises felt, polymer foam, cardboard, material such as cotton, or combinations thereof.

In use the drip catcher is arranged round bottle 10. The label can be removed so that the collecting member remains behind on the bottle (FIG. 26).

The imprint can be applied to any desired part of the drip catcher, such as on the first part or the second part of the label element and/or on the collecting member.

The production costs of the drip catcher according to the present invention are low enough to provide bottles with the drip catcher prior to purchase. The drip catcher thus offers companies an attractive option for providing the bottles and other liquid containers they offer with a distinctive feature. The use of the drip catcher will also increase because it is already arranged round the bottle.

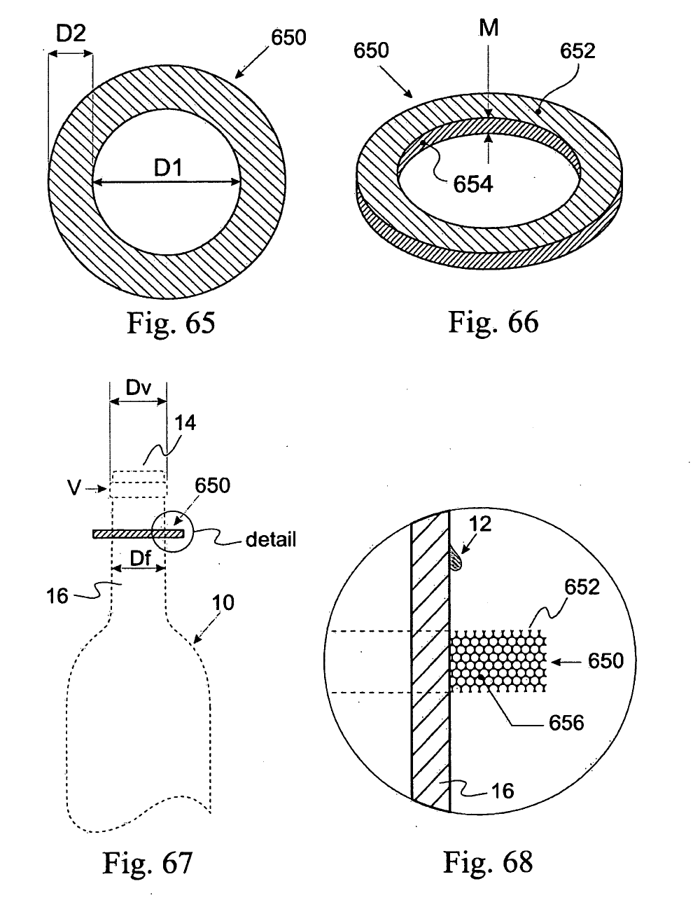

An additional example of a practical embodiment is as follows. The inner diameter D1 (FIG. 65) of the annular collecting member is a little smaller than the outer diameter of (neck 16 of) liquid container 10 for which the drip catcher is intended. Inner diameter D1 is in practice for instance in the order of 25 mm. The thickness M of the collecting member can be relatively small (FIG. 66). Thickness M is for instance between about 1.5 and about 4 mm. The label element can have the same thickness, for instance when the label is of the same material.

The operation of the drip catcher is based for instance on the combination of cell structure 656, inner wall 654 and upper surface 652 (FIG. 66, 68). After drink has been poured from bottle 10, the bottle is set down in upright position, wherein a droplet 12 runs downward from bottle opening 14 along the neck 16 of the bottle in the direction of drip catcher 650. The porous inner wall 654 of the annular collecting member is situated between bottle neck 16 and drip catcher 650. As soon as droplet 12 reaches surface 652 and 654, it is spread around bottle neck 16 by the capillary action and the surface tension of the moisture of droplet 12. The droplet is herein absorbed by upper surface 652. In addition, the droplet is suctioned into the drip catcher by the capillary action of both surface 652 and surface 654.

In another embodiment the absorbent material from which the collecting member of the drip catcher is manufactured is characterized by a (more or less) closed cell structure. In the production of this absorbent material larger volumes are processed into thinner layers (sheet material). Only the surface of this sheet material hereby consists mainly of opened cells with the resulting absorbent capacity.

The absorbent material can for instance comprise EVA foam (ethylene vinyl acetate). EVA has a structure substantially corresponding with the cell structure 656 as shown in FIG. 68.

Because the absorbent sheet material consists of a (more or less) closed cell structure, and only the cells on the surface are open, (wine) droplets cannot permeate deeply into the drip catcher. The drip catcher is hereby readily cleaned, for instance under a running tap. The absorbent material from which the drip catcher is manufactured (for instance EVA) is built up of very small cells. The surface of the drip catcher is hereby highly suitable for printing, even when the relevant images are reasonably detailed.

The material from which the drip catcher is manufactured (for instance EVA) is flexible and resilient. In addition, the material is highly tear-resistant. The drip catcher, even at a small diameter D2 (FIG. 65), can hereby be placed over and removed once again from bottle necks without tearing, even if a thickened portion V on the top side thereof (FIG. 67) has a considerably larger diameter Dv than the outer diameter Df of the bottle neck.

In all the above described embodiments the collecting member of the drip catcher can have a colour, for instance (dark) red or black, such that it corresponds to or is darker than the liquid in the liquid container. Absorbed liquid, for instance red wine, does not therefore result, or hardly so, in visible discoloration of the collecting member.

The present invention is not limited to the above described embodiments thereof, in which many modifications are possible within the scope of the appended claims.

1. A drip catcher for a liquid container, comprising an at least partially elastic collecting member for collecting droplets during pouring of liquid out of the liquid container.

2. The drip catcher as claimed in claim 1, comprising a label element coupled to the collecting member.

3. The drip catcher as claimed in claim 2, wherein the label element is an elongate card.

4. The drip catcher as claimed in claim 2, wherein the label element comprises a first opening with an edge provided with a number of protrusions for coupling the label element and the collecting member.

5. The drip catcher as claimed in claim 3, wherein the label element is coupled releasably to the collecting member, and wherein a label element detached from the collecting member comprises a second opening for the purpose of arranging the label element therewith to for instance a door handle.

6. The drip catcher as claimed in claim 2, wherein the label element is of the same material as the collecting member.

7. The drip catcher as claimed in any of the claim 3, wherein the label element comprises:
a first opening for coupling thereto of the collecting member, and
a second opening for arranging the label element therewith round the liquid container.

8. The drip catcher as claimed in claim 2, wherein the label element extends around the whole liquid container and comprises a card folded along fold lines for the purpose of forming a spatial form.

9. The drip catcher as claimed in claim 8, wherein the spatial form comprises a triangular container, a substantially square beam and/or a pyramid form.

10. The drip catcher as claimed in claim 2, wherein the label element is a door hanger.

11. The drip catcher as claimed in claim 2, wherein the label element comprises a narrowed portion.

12. The drip catcher as claimed in claim 11, wherein the label element has a substantially arrow-shaped outer end.

13. The drip catcher as claimed in any of the claim 1, wherein the collecting member comprises an elastic part substantially for exerting a clamping force, and an absorbent part co-acting with the elastic part for the purpose of absorbing the droplets, and
wherein the elastic part of the collecting member comprises a core of a number of bundled elastic threads.

14. The drip catcher as claimed in claim 13, wherein the absorbent part of the collecting member comprises a jacket of an absorbent material arranged round the core.

15. The drip catcher as claimed in claim 14, wherein the jacket is relatively thin compared to the core.

16. The drip catcher as claimed in any of the claim 13, wherein the collecting member has an annular form with an inner diameter (D1) of about 25 mm and/or a diameter (D2) of between about 1.5 and about 4 mm.

17. A Label element for use in combination with the drip catcher as claimed in claim 1.

18. A method comprising of the use of a drip catcher as claimed in claim 1.
